(19) United States
(12) Patent Application Publication
(10) Pub. No.: US 2024/0022423 A1
(43) Pub. Date: Jan. 18, 2024

(54) PROCESSING PRIVATE INFORMATION IN A DISTRIBUTED ENCLAVE FRAMEWORK

(71) Applicant: Meta Platforms, Inc., Menlo Park, CA (US)

(72) Inventors: Shankaran Gnanashanmugam, Sunnyvale, CA (US); Qi Guo, Redmond, WA (US); Xiaopeng Wu, Kenmore, WA (US); Yantao Li, Sammamish, WA (US); Anant Deepak, San Jose, CA (US)

(21) Appl. No.: 17/199,807

(22) Filed: Mar. 12, 2021

(51) Int. Cl. H04L 9/32; G06N 20/00

(52) U.S. Cl. CPC H04L 9/3236; G06N 20/00; G06Q 30/0253

(57) ABSTRACT

A request for information to verify integrity of program code of a first processor enclave is received from a remote requestor via a network. The requested information is provided. Private information for use by the program code of the first processor enclave is received. The program code of the first processor enclave is used to select based at least in part on the received private information a second processor enclave among a plurality of different processor enclave options. Integrity of program code of the selected second processor enclave is verified. At least a portion of the received private information is provided to the selected second processor enclave for processing by the verified program code of the selected second processor enclave.

### BACKGROUND OF THE INVENTION

Computer security (also referred to as cybersecurity, information technology security, and so forth) involves safeguarding computer systems and networks against attacks. Weaknesses in design, implementation, and/or operation of computer systems and networks can be exploited by malicious actors. For example, hackers may exploit computer system and network vulnerabilities to steal sensitive information. Sensitive information can include personally identifiable information (PII), financial information, and other personal information. Specific examples of sensitive information include a person's name, email address, home address, date of birth, phone number, social security number, bank account number, passport number, credit card number, biometric records, and other information, such as medical, educational, financial, and employment information. Sensitive information (also referred to as private information, private data, etc.) can also include business, technical, or other proprietary information that if accessed by anyone other than the owner of the information could result in harm to the owner's business, legal, or other interests. In many scenarios, measures taken to make computer systems and networks more secure have an unfavorable effect on computing performance. Thus, it would be beneficial to develop techniques directed toward improving computer security while also preserving computing performance.

### BRIEF DESCRIPTION OF THE DRAWINGS

Various embodiments of the invention are disclosed in the following detailed description and the accompanying drawings.

FIG. 1 is a block diagram illustrating an embodiment of a system for handling private information.

FIG. 2 is a block diagram illustrating an embodiment of an orchestrator and worker system for processing private information.

FIG. 3 is a flow chart illustrating an embodiment of a process for processing private information received from a remote requestor.

FIG. 4 is a diagram illustrating an embodiment of a system for electronic commerce advertising processing.

FIG. 5 is a flow chart illustrating an embodiment of a process for processing private information associated with electronic commerce advertising.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Processing private information in a distributed enclave framework is disclosed. A request for information to verify integrity of program code of a first processor enclave is received from a remote requestor via a network. The requested information is provided. Private information for use by the program code of the first processor enclave is received. The program code of the first processor enclave is used to select based at least in part on the received private information a second processor enclave among a plurality of different processor enclave options. Integrity of program code of the selected second processor enclave is verified. At least a portion of the received private information is provided to the selected second processor enclave for processing by the verified program code of the selected second processor enclave.

A practical and technological benefit of the techniques disclosed herein is preservation of privacy while utilizing a distributed computing framework to meet computing performance requirements. Prior approaches are deficient because either privacy is not maintained while distributing computing load or computing performance suffers in order to maintain privacy. The techniques disclosed herein solve the problem of verifying trustworthiness of computing resources within a distributed computing framework before sharing private information within the computing framework. Privacy problems are solved by utilizing enclave applications running in a trusted execution environment (TEE). As used herein, a TEE refers to a secure area of a computer processor that guarantees that computer code (also referred to as source code, program code, code, etc.) and data loaded within the TEE are protected with respect to confidentiality and integrity. Stated alternatively, a TEE is an execution space that provides a higher level of security. Oftentimes, the TEE includes its own microprocessor that executes computer code. An enclave (also referred to as a processor enclave, secure enclave, etc.) is an isolated memory region of computer code and data that can be used to run applications in a TEE. Enclave contents are protected by processor hardware from being attacked and accessed from outside the TEE. Enclave applications/processes refer to applications/processes running inside a TEE.

In various embodiments, before private data is sent to an enclave application for processing, the sender of the private data requires verification of the identity of the enclave application. The process of verifying an enclave application is referred to as attestation. Remote attestation refers to attestation that occurs when the sender of the private data is a remote sender (e.g., a sender that connects to the enclave application via a computer network). In various embodiments, remote attestation allows the sender to cryptographically verify the enclave application's identity and also that the enclave application is intact (has not been tampered with) and is running securely within an enclave. In various embodiments, a cryptographic hash of the enclave application is utilized to determine enclave application identity. A cryptographic hash refers to an algorithm (and/or output thereof) that converts an input (of an arbitrary size, such as an arbitrary amount of computer code) to a fixed-size output of encrypted text. In various embodiments, attestation is specific to a hardware manufacturer so that service providers receiving private data (e.g., cloud service providers) need not be trusted. For example, computer hardware within a TEE may perform cryptographic hashing, meaning the hash results are secure as long as the TEE is secure. Therefore, a sender of private data can validate source code and ensure the private data is not shared with any entities apart from attested source code. In various embodiments, the enclave application ensures that private data received from a remote sender after successful attestation does not leave the enclave and that the enclave application does not share/move the private data to any other entities (even to other enclaves). The reason is that if the data leaves the enclave, then remote attestation would not be regarded as successful because the data can be misused by the other entities that receive the data. Stated alternatively, the remote attestation that is done at runtime for a first enclave does not guarantee operations of another enclave.

In various embodiments, private data is received by a distributed system. In a distributed system, processing occurs at different layers of an infrastructure by different services. Thus, a technical problem that must be solved is how to ensure that distributed services are able to access data of an enclave application without losing the privacy guarantee provided by remote attestation. In some embodiments, a single enclave application that comprises all the operations performed on the data is utilized. This enclave application can operate in different modes based on the role being performed by the enclave application. Thus, the whole functional enclave can be attested before receiving private data. Different distributed services can operate as an equivalent enclave in different modes. In some embodiments, a first enclave service performs remote attestation and ensures another enclave service is an equivalent enclave before sharing private data with that other enclave service. For example, as described in further detail herein, a distributed service may be comprised of an identity matching service and additional advertising-related services that can be built into a single enclave application that is presented for remote attestation. The enclave application can be invoked to perform identity matching in a first mode and other services in a second mode. In some embodiments, the identity matching service receives private data after remote attestation, attests the other services, and then sends the private data for the other services.

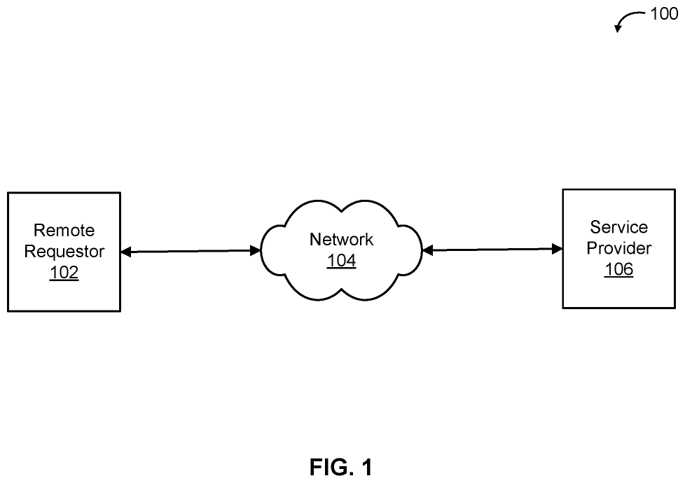

FIG. 1 is a block diagram illustrating an embodiment of a system for handling private information. In the example shown, system 100 includes remote requestor 102, network 104, and service provider 106.

In various embodiments, remote requestor 102 includes one or more computers or other hardware components that store sensitive information, such as PII, and other personal, proprietary, financial, legal, or technical information. In various embodiments, remote requestor 102 possesses private information (that it cannot fully process) to be sent to a remote service provider for further processing. In the example illustrated, remote requestor 102 is communicatively connected to service provider 106 via network 104. Requests are transmitted from remote requestor 102 to and responses received from service provider 106 using network 104. Examples of network 104 include one or more of the following: a direct or indirect physical communication connection, mobile communication network, Internet, intranet, Local Area Network, Wide Area Network, Storage Area Network, and any other form of connecting two or more systems, components, or storage devices together. In various embodiments, service provider 106 includes one or more computers or other hardware components that are utilized to provide a service for remote requestor 102. For example, in some embodiments, service provider 106 utilizes private information provided by remote requestor 102 to look up information associated with the private information and returns a result to remote requestor 102.

In various embodiments, remote requestor 102 requires that only specified processing be performed on private information that it transmits to server provider 106. In various embodiments, remote requestor 102 verifies computer code used by service provider 106 to process the private information before transmitting the private information to service provider 106. This verification is referred to as attestation (in this case, remote attestation because service provider 106 is remotely connected via network 104) and allows remote requestor 102 to send private data for secure processing. In various embodiments, the identity of software/computer code that processes the private information is attested to by comparing a hash of the software/computer code.

In some embodiments, remote requestor 102 is associated with a system that displays digital advertisements to users over the Internet. For example, a user may have made a purchase by clicking on an advertisement initially generated by remote requestor 102. Remote requestor 102 could have private information (e.g., an e-mail address) of the user after the purchase, but remote requestor 102 may not possess information as to where the user viewed the advertisement because the advertisement is presented on various websites and/or social media platforms. Remote requestor 102 may then query various service providers (e.g., service provider 106) to determine which service provider presented the advertisement to the user. In order for a service provider to respond, it must perform identity matching associated with the user and would thus require private information associated with the user (e.g., the e-mail address). In order to achieve privacy, remote requestor 102 connects to an enclave of service provider 106 and performs attestation before sending the private information (e.g., the e-mail address). As described in further detail herein, the techniques disclosed herein solve the attestation problem for scenarios in which service provider 106 provides functionality that is scalable and implemented in a distributed manner.

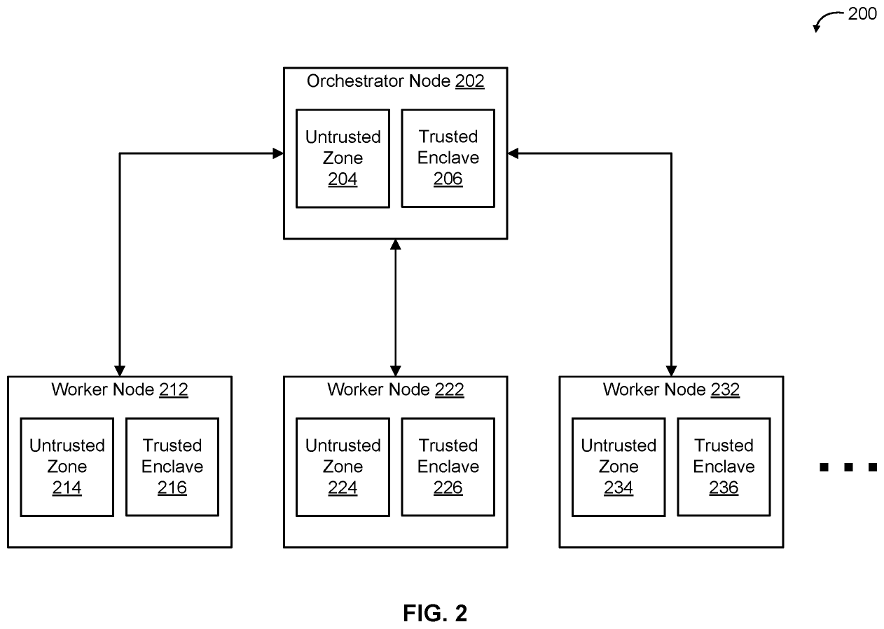

FIG. 2 is a block diagram illustrating an embodiment of an orchestrator and worker system for processing private information. In the example illustrated, system 200 includes orchestrator node 202 and a plurality of worker nodes (worker nodes 212, 222, and 232 are shown). In some embodiments, system 200 is included in service provider 106 of FIG. 1.

System 200 is an orchestrator/worker model that is scalable. In various embodiments, orchestrator 202 is responsible for connecting with a remote requestor (e.g., remote requestor 102 of FIG. 1) and then interfacing with worker nodes. In various embodiments, orchestrator node 202 includes one or more computers hardware components (e.g., one or more computer processors with computer memory) configured to handle data and execute computer code. In the example illustrated, orchestrator node 202 comprises untrusted zone 204 and trusted enclave 206.

Untrusted zone 204 comprises a memory region of orchestrator node 202 that is not part of a TEE. Stated alternatively, untrusted zone 204 comprises a memory region whose contents are not guaranteed to stay within untrusted zone 204. An example of memory includes random-access memory (RAM). As is well known in the art, primary storage can be used as a general storage area and as scratch-pad memory, and can also be used to store input data and processed data. In various embodiments, the memory is a primary storage. Primary storage can store programming instructions and data, in the form of data objects and text objects, in addition to other data and instructions for processes operating on orchestrator node 202. A processor of orchestrator node 202 can also directly and very rapidly retrieve and store frequently needed data in a cache memory.

Trusted enclave 202 is a processor enclave of orchestrator node 202. In some embodiments, a remote requestor (e.g., remote requestor 102 of FIG. 1) connects to trusted enclave 206 and sends private information to trusted enclave 206. In some embodiments, orchestrator node 202 duplicates the private information received by trusted enclave 206 and sends the information to trusted enclaves of one or more worker nodes. In the example illustrated, each worker node also comprises an untrusted zone and trusted enclave (untrusted zone 214 and trusted enclave 216 for worker node 212, untrusted zone 224 and trusted enclave 226 for worker node 222, and untrusted zone 234 and trusted enclave 236 for worker node 232). In various embodiments, each worker node includes one or more computers hardware components (e.g., one or more computer processors with computer memory) configured to handle data and execute computer code. Each worker untrusted zone comprises a memory region that is not part of a TEE, and each worker trusted enclave is a processor enclave.

Because private information is transferred from orchestrator node 202 to one or more worker nodes, privacy of the private information would be lost for a remote requestor that performed remote attestation with orchestrator node 202 only. Privacy would be lost even though the private information is moving from one processor enclave to another processor enclave. The techniques disclosed herein allow for private information to be transferred to processor enclaves of the worker nodes while maintaining privacy of the private information.

In various embodiments, a remote requestor (e.g., remote requestor 102 of FIG. 1) possesses a copy of computer code that it expects system 200 to utilize to process private information and/or a cryptographic hash of the computer code (also referred to as source code, program code, code, etc.) generated by a hashing function/algorithm. Examples of functions/algorithms to generate the cryptographic hash include Secure Hash Algorithm 256 (SHA256) and Message-Digest algorithm 5 (MD5). In various embodiments, the remote requestor generates a computer hash using the source code (to be utilized on the private information). In various embodiments, this source code is a complete solution for processing to be performed on the private information (e.g., includes both identity matching and advertisement conversion/attribution in various advertising contexts). In some embodiments, this source code comprises trusted enclave 206 and also the various processor enclaves of the worker nodes (trusted enclaves 216, 226, and 236 in the example shown). In various embodiments, the remote requestor connects to system 200 (with orchestrator node 202 being a single point of entry) to request a hash of the source code and system 200 provides a hash of source code that is the same for orchestrator node 202 and the worker nodes. This is because, in various embodiments, orchestrator node 202 and the worker nodes possess the same source code but operate in different modes depending on whether the node is orchestrator node 202 or a worker node. The remote requestor, upon receiving the hash from system 200 can compare the hash to its own hash and verify that the source code that system 200 will execute matches with the source code the remote requestor expects system 200 to execute. In various embodiments, the hash is a session-based hash whose details are derived from a hardware manufacturer of the processor enclaves; thus, the remote requestor does not need to trust system 200 as a whole.

A benefit of orchestrator node 202 and the worker nodes possessing the same source code but operating in different modes is that scalability can be achieved while preserving privacy. Because the nodes execute the same source code, private information can be shared between the nodes while still attesting to the remote requestor the identity of all source code that handles the private information. Such an approach is beneficial in part because it may not be feasible for the remote requestor to directly communicate with worker nodes after the worker nodes have been assigned their tasks by orchestrator node 202. Stated alternatively, having a single point of entry, orchestrator node 202, for the remote requestor is an advantage. In this manner, the remote requestor does not need to possess information as to system 200's architecture/infrastructure, which makes a request to process private information simpler from the remote requestor's perspective. In various embodiments, in order for orchestrator node 202 to share private information with a worker node, orchestrator node 202 compares a hash of its source code with a hash of the worker node's source code to verify that the worker node possesses the same source code as orchestrator node 202.

In some alternative embodiments, the remote requestor communicates more than once with system 200. For example, the remote requestor may first perform remote attestation for orchestrator node 202, after which orchestrator node 202 may communicate to the remote requestor a hash for a worker node that will perform further processing of the private information, and then the remote requestor performs a separate remote attestation for the worker node. Stated alternatively, private information may be exchanged according to a two-hash procedure in which orchestrator node 202 and each worker node are not required to execute the same source code. A potential benefit is more streamlined and optimized source code for orchestrator node 202 and the worker nodes.

In some embodiments, system 200 processes private information received from an advertiser remote requestor. In this advertising context, in various embodiments, system 200 performs identity matching of private information to a user identity and then performs additional advertising related processing. In an advertising context, identity matching oftentimes must be partitioned across different computing resources because of hardware (e.g., memory limitations). For example, it may not be possible to store all user names and user information in one computing node. Rather, data of user names that start with letters A-F may be stored in one computing node, data of user names that start with letters G-L may be stored in another computing node, and so forth. Thus, in various scenarios, an orchestrator/worker model as is shown for system 200 is required to handle advertising related processing. A further requirement may be that the model be scalable to accommodate additional computing nodes as more users are added. In various embodiments, in the orchestrator/worker model, whether a trusted enclave acts as the orchestrator or a worker is based on a configuration/invocation for that computing node. In some embodiments, identity matching includes determining whether an e-mail address or other private information matches to a user. In some embodiments, each worker node handles a subset of users and determines whether a matched user has been presented with an advertisement. Information about the user and the user's advertising engagement history can also be sent to another worker node that is responsible for machine learning training (each purchase or lack of purchase by a user after being presented with advertising is information that can be utilized to build a recommendation model for that user).

As an example, suppose each enclave comprises computer code for a worker mode (e.g., code for identity matching, determining a user was shown an advertisement, and passing user information along for machine learning training) as well as computer code for an orchestrator mode. An advertiser remote requestor may expect processing by a worker node enclave E. The cryptographic hash for E could be EH. The advertiser remote requestor may first connect to orchestrator node enclave E′, whose cryptographic will also be EH because E and E′ comprise the same computer code (but portions of the computer code are not utilized for each mode of operation). The orchestrator node can connect to various worker nodes and verify a cryptographic hash of EH for each worker node. Thus, even though private information moves from one enclave to another enclave, the privacy guarantee is preserved because the data movement is only to other instances of the same computer code running in different modes and the entire computer code is attested as part of the connection between the advertiser remote requestor and the orchestrator node.

In the example shown, portions of the communication path between the components are shown. Other communication paths may exist, and the example of FIG. 2 has been simplified to illustrate the example clearly. Although single instances of components have been shown to simplify the diagram, additional instances of any of the components shown in FIG. 2 may exist. The number of components and the connections shown in FIG. 2 are merely illustrative. Components not shown in FIG. 2 may also exist.

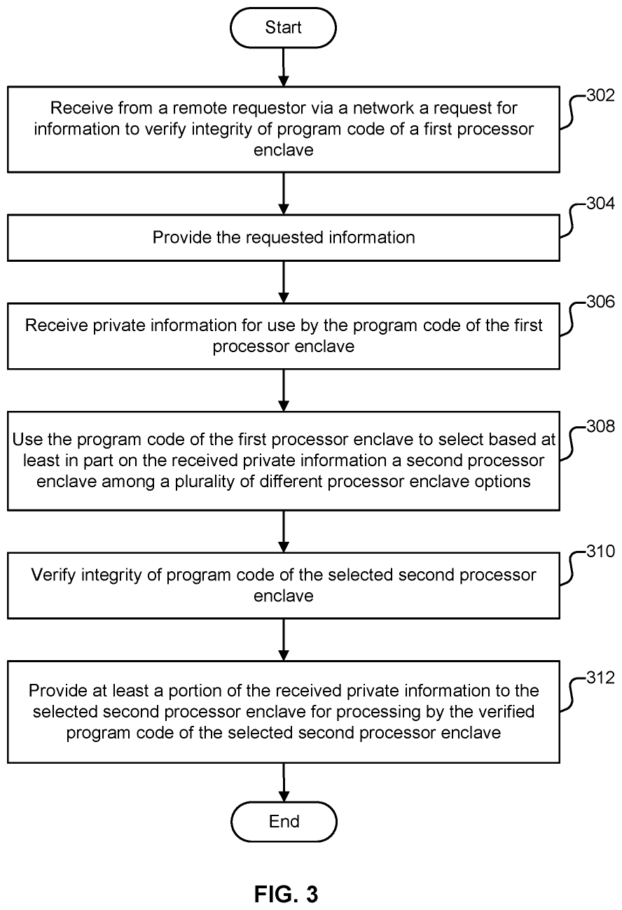

FIG. 3 is a flow chart illustrating an embodiment of a process for processing private information received from a remote requestor. In some embodiments, the process of FIG. 3 is performed by service provider 106 of FIG. 1 and/or system 200 of FIG. 2.

At 302, a request for information to verify integrity of program code of a first processor enclave is received from a remote requestor. In some embodiments, the request for information includes a request for a cryptographic hash of the program code of the first processor enclave. The cryptographic hash can be compared to a cryptographic hash possessed by the remote requestor to verify the program code is the program code expected by the remote requestor. In some embodiments, the remote requestor is remote requestor 102 of FIG. 1. In some embodiments, the request for information is received by orchestrator node 202 of FIG. 2.

At 304, the requested information is provided. In some embodiments, a cryptographic hash of the program code of the first processor enclave is provided. In various embodiments, the requested information is transmitted to the remote requestor via a network (e.g., network 104 of FIG. 1).

At 306, private information for use by the program code of the first processor enclave is received. In some embodiments, the private information includes an e-mail address. Other examples of private information include: a person's name, home address, date of birth, phone number, social security number, bank account number, passport number, credit card number, biometric records, and other information, such as medical, educational, financial, and employment information as well as other business, technical, or proprietary information.

At 308, the program code of the first processor enclave is used to select based at least in part on the received private information a second processor enclave among a plurality of different processor enclave options. In some embodiments, the first processor enclave is part of an orchestrator node (e.g., orchestrator node 202 of FIG. 2) in an orchestrator/worker model. In various embodiments, the second processor enclave is part of one of the worker nodes of system 200 of FIG. 2, with the various trusted enclaves of the worker nodes of system 200 being the plurality of different processor enclave options. In various embodiments, the private information indicates which of the various worker nodes in the orchestrator/worker model is appropriate to handle the request from the remote requestor and return the requested information. For example, if the private information is a name, the various worker nodes may be assigned subsets of users to search for based on the first letter of the last name (e.g., a first worker node is responsible for last names that start with the letters A through C, a second worker node is responsible for last names that start with the letters D through F, and so forth). Similarly, if the private information is an e-mail address, the various worker nodes may be partitioned according to e-mail address.

In some embodiments, the first processor enclave determines which of the plurality of different processor enclave options to choose based on a hash table lookup. As used herein, a hash table refers to a data structure that maps keys (e.g., e-mail addresses) into an array of locations storing the keys. Given a key, a hash function (also referred to as a hash code) can be utilized to determine its storage location. For example, given an e-mail address (or some other private information), orchestrator node 202 of FIG. 2 may utilize a hash function to determine which worker node stores information associated with the e-mail address (e.g., user name, advertisements presented to the user, and other information of interest to the remote requestor). The above example is illustrative and not restrictive. In general, the first processor enclave may utilize any mapping technique to map private information to the plurality of different processor enclave options and thus map received private information to look up and select the second processor enclave.

At 310, the integrity of program code of the selected second processor enclave is verified. In some embodiments, the first processor enclave verifies the integrity of the program code of the selected second processor enclave. In some embodiments, the first processor enclave verifies the integrity of the program code of the selected second processor enclave by requesting the selected second processor enclave to provide a hash of its program code and comparing the provided hash with a hash of the program code of the first processor enclave. If the two hashes match, then it is determined that the program codes match and the integrity of the program code of the selected second processor enclave is verified.

In an alternative embodiment, the integrity of the program code of the selected second processor enclave is verified by the remote requestor. For example, a hash of the program code of the selected second processor enclave can be transmitted to the remote requestor for verification. Upon verification by the remote requestor, the remote requestor can provide the private information to the selected second processor enclave or instruct the first processor enclave to share the private information with the selected second processor enclave.

At 312, at least a portion of the received private information is provided to the selected second processor enclave for processing by the verified program code of the selected second processor enclave. In some embodiments, the private information is provided to the selected second processor enclave by the first processor enclave. It may also be provided by the remote requestor (e.g., in the alternative embodiment described above). In some embodiments, the processing by the verified program code of the selected second processor enclave includes looking up a user and/or user associated information corresponding to the private information. For example, the selected second processor enclave may determine whether the user was presented with a specified digital advertisement (e.g., an advertisement displayed on a specified website or social media platform).

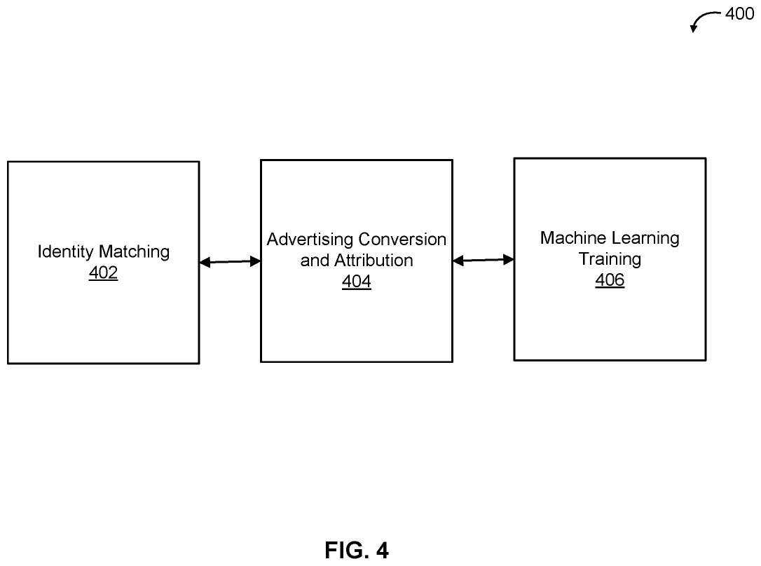

FIG. 4 is a diagram illustrating an embodiment of a system for electronic commerce advertising processing. In some embodiments, at least a portion of system 400 is included in service provider 106 and/or system 200 of FIG. 2.

In the example illustrated, system 400 includes identity matching 402, advertising conversion and attribution 404, and machine learning training 406. In some embodiments, a workflow for system 400 includes a remote requestor connecting to a processor enclave of system 400 to perform remote attestation and send private information. In some embodiments, the remote requestor is remote requestor 102 of FIG. 1. In some embodiments, an orchestrator node (not shown in FIG. 4), e.g., orchestrator node 202 of FIG. 2, communicates with the remote requestor to perform the remote attestation and receive the private information. Examples of private information (that can be used to identify a user whose information is stored in system 400) include an e-mail address of the user and an Internet Protocol (IP) address of the user. In various embodiments, the private information is utilized by at least a portion of system 400 to determine information of interest to send back to the remote requestor. In various embodiments, a lookup is performed based on the private information. In various embodiment, additional processing is performed based on a result of the lookup.

In various embodiments, identity matching 402 includes a distributed secure computing environment. For example, identity matching 402 may be comprised of a plurality of processor enclaves to receive the private information and perform a lookup of the private information. In many scenarios, distributing the lookup is required because the number of users to search to perform identity matching is too large to fit within a single processor enclave. Stated alternatively, user information oftentimes needs to be loaded into multiple processor enclaves. In various embodiments, identity matching 402 includes matching an offsite conversion of a local user (e.g., matching a purchase of a product to a user stored in system 400). In some embodiments, an orchestrator node determines a processor enclave within identity matching 402 to perform a lookup. It is also possible for a lookup to be performed by multiple processor enclaves in parallel and a result returned from one of the processor enclaves. In various embodiments, the orchestrator node attests the multiple processor enclaves before sharing private information with them.

In some embodiments, identity matching comprises utilizing lookup logic to find a user to match received private information. For example, an e-mail address as private information may be used to find a corresponding user name and information associated with the user's engagement with advertising. N rows of data may be determined, wherein N equals the number of user advertisement engagements for the matched user. In some embodiments, each row of data comprises a user identifier (e.g., a user name or number), an advertisement identifier (identifying a specified advertisement), and a timestamp of when the specified advertisement was presented to the user. In various embodiments, identity matching 402 also receives other data associated with the request in addition to information utilized to identify a user. For example, information associated with a purchase can be provided by the remote requestor (e.g., time of purchase, item purchased, purchase price, etc.). This information can be utilized by advertising conversion and attribution 404 and machine learning training 406. As used herein, conversion and attribution refer to combining system 400 advertising data and remote requestor purchase data to give credit for a product purchase. As used herein, label generation refers to determining whether a user purchased an item or not after being presented with an advertisement (a final recording step, e.g., recording a 0 label for no purchase and a 1 label for a purchase).

In various embodiments, advertising conversion and attribution 404 is comprised of processing hardware configured to generate labels associated with information determined by identity matching 402. In some embodiments, computing logic for advertising conversion and attribution 404 resides in the same processor enclave as each corresponding component of identity matching 402. It is also possible for advertising conversion and attribution 404 to reside in an untrusted zone (e.g., an untrusted zone of a worker node in system 200 of FIG. 2) if the private information utilized for identity matching is not used (e.g., if users are only identified with identifiers that do not reveal private information). In various embodiments, advertising conversion and attribution 404 compares a time of purchase (e.g., a timestamp indicating time of purchase received along with the private information) with timestamps (e.g., in N rows of data) indicating times that advertisements were presented to a user. In some embodiments, a specified advertisement is credited with causing the user to make a purchase if the advertisement (as indicated by its timestamp) was presented to the user a specified amount of time before the purchase was made. In some embodiments, the advertisement closest in time to the time of purchase (but not after the time of purchase) is credited with causing the purchase. In some embodiments, each row of data received from identity matching 402 is modified to further include a conversion label, wherein the label value is 0 for advertisements that did not cause the purchase and the label value is 1 for the advertisement that caused the purchase. In some embodiments, the advertisement with the label value of 1 is reported to an orchestrator node (e.g., orchestrator node 202 of system 200 of FIG. 2), which compares the advertisement information (e.g., product advertised) with information received from a remote requestor (e.g., product purchased) to confirm that a specified service (e.g., service provider 106 of FIG. 1) was responsible for advertising to the user and causing the user to purchase the product and report this information back to the remote requestor, which can credit the specified service for successfully advertising to the user.

In various embodiments, machine learning training 406 is comprised of processing hardware configured to train a machine learning model associated with presenting user targeted advertisements. Machine learning refers to a framework for using and developing computer systems that are able to learn and adapt without following explicit instructions, e.g., by using algorithms and statistical models to analyze and draw inferences from patterns in data. A machine learning model refers to an automated prediction mechanism or procedure (e.g., in computer code form) that results from training the automated prediction mechanism on manually provided training data. Training the automated prediction mechanism comprises iteratively tuning and adjusting the prediction mechanism (e.g., rules, algorithms, etc.) so that outputs of the prediction mechanism (the prediction outputs) fit the known, correct outputs associated with the training data. Mappings between training data inputs and outputs are known a priori, e.g., because they are determined through human review. Stated alternatively, a machine learning model represents what is learned by a machine learning algorithm (a procedure applied to input data to arrive at an output prediction) after the machine learning algorithm is tuned according to training data. A trained machine learning model can be utilized to generate outputs associated with input data whose true, correct outputs are not known a priori, which is referred to as utilizing the machine learning model in inference mode (as opposed to training mode when the machine learning model is tuned based on training data). Examples of machine learning models include neural networks of various architectures (e.g., feed forward (FF), recurrent neural network (RNN), convolutional neural network (CNN), long/short term memory (LSTM), and so forth).

In some embodiments, machine learning training 406 receives information outputted by advertising conversion and attribution 404 (e.g., N rows of data, wherein each row includes a user identifier, an advertisement identifier, and a label indicating whether the advertisement was successful). In various embodiments, the user identifier does not reveal private information concerning the user. Thus, computing logic for machine learning training 406 can reside in untrusted zones (e.g., in untrusted zones of worker nodes in system 200 of FIG. 1). An advantage of such an approach is conserving enclave memory resources. In some scenarios, machine learning training logic may require too much memory to store within processor enclaves. In various embodiments, for each user of system 400, a profile of the user's advertisement preferences is generated based on training a machine learning model on prior successful advertisements (label of 1) and prior unsuccessful advertisements (label of 0). For example, a neural network can be trained based on inputs of various advertisements in feature vector form, wherein each feature vector comprises various parameters associated with an advertisement (e.g., keywords, presentation mode (e.g., pop-up, graphical, text only, etc.), product type, product price, advertiser identity, etc.) accompanied by output labels indicating success status.

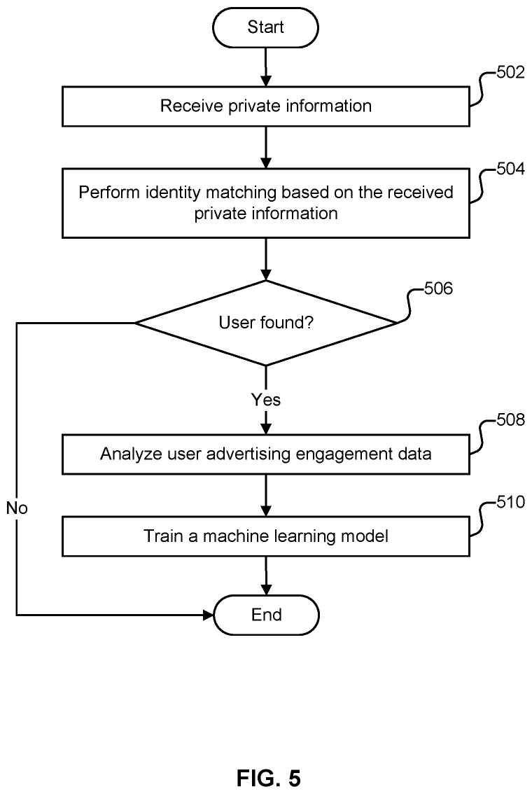

FIG. 5 is a flow chart illustrating an embodiment of a process for processing private information associated with electronic commerce advertising. In some embodiments, the process of FIG. 5 is performed by system 400 of FIG. 4.

At 502, private information is received. In some embodiments, the private information is received by identity matching 402 of system 400 of FIG. 4. Examples of private information include a name of a person or a person's e-mail address. In various embodiments, the private information is received in a processor enclave from anther processor enclave (e.g., an orchestrator node, such as orchestrator node 202 of FIG. 2).

At 504, identity matching is performed based on the received private information. In some embodiments, the identity matching is performed by identity matching 402 of system 400 of FIG. 4. In various embodiments, a lookup of the private information is performed to determine whether a user matching the private information (e.g., name or e-mail address) has been found.

At 506, it is determined whether a user has been found (matching the private information). If at 506 it is determined that a user has been found, then further processing of information associated with the user is performed at 508 and 510. It at 506 it is determined that no user has been found matching the private information, then no further processing is performed based on the received private information.

At 508, user advertising engagement data is analyzed. In some embodiments, advertising conversion and attribution 404 of system 400 of FIG. 4 analyzes the user data. In various embodiments, the advertising engagement data includes timing of advertisements presented to the user, products advertised by the advertisements, and whether the user clicked and/or viewed the advertisements. The advertising engagement data is utilized to determine whether the user was presented with an advertisement in connection with a purchase of a product communicated to system 400 by a remote requestor (e.g., remote requestor 102). In various embodiments, a result indicating whether the user purchased the product as a result of one of the advertisements is reported back to the remote requestor.

At 510, a machine learning model is trained. In some embodiments, the machine learning model training is performed by machine learning training 406 of system 400 of FIG. 4. In various embodiments, the machine learning model is trained to predict future advertisements that are likely to lead to product purchases by the user and/or products that the user is likely to purchase in the future. In various embodiments, training data for the machine learning model includes advertisements (and properties of those advertisements) presented to the user accompanied by labels indicating whether the advertisements resulted in product purchases.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving from a remote requestor via a network a request for information to verify integrity of program code of a first processor enclave;
providing the requested information;
receiving private information for use by the program code of the first processor enclave;
using the program code of the first processor enclave to select based at least in part on the received private information a second processor enclave among a plurality of different processor enclave options;
verifying integrity of program code of the selected second processor enclave; and
providing at least a portion of the received private information to the selected second processor enclave for processing by the verified program code of the selected second processor enclave.

2. The method of claim 1, wherein the remote requester is associated with electronic commerce.

3. The method of claim 1, wherein the requested information includes a cryptographic hash associated with the program code of the first processor enclave.

4. The method of claim 3, wherein the cryptographic hash is generated within a trusted execution environment associated with the first processor enclave.

5. The method of claim 1, wherein the remote requestor possesses a copy of the program code of the first processor enclave.

6. The method of claim 1, wherein the remote processor is able to verify the integrity of the program code of the first processor enclave including by matching the requested information with a version of the requested information stored by the remote requestor.

7. The method of claim 1, wherein the private information includes personally identifiable information.

8. The method of claim 1, wherein the private information includes at least one of the following: a person's name, an e-mail address, or an Internet Protocol address.

9. The method of claim 1, wherein the program code of the first processor enclave and the program code of the selected second processor enclave are identical.

10. The method of claim 9, wherein the identical program code of the first processor enclave and the selected second processor enclave are configured to operate in different modes.

11. The method of claim 1, wherein using the program code of the first processor enclave to select based at least in part on the received private information the second processor enclave includes utilizing the received private information to select a processor enclave among the plurality of different processor enclave options that stores information associated with a user corresponding to the received private information.

12. The method of claim 1, wherein verifying the program code of the selected second processor enclave includes requesting a cryptographic hash corresponding to the program code of the selected second processor enclave from the selected second processor enclave, receiving the cryptographic hash, and comparing the received cryptographic hash with a cryptographic hash corresponding to the program code of the first processor enclave.

13. The method of claim 1, wherein the program code of the first processor enclave is different from the program code of the selected second processor enclave.

14. The method of claim 1, wherein verifying the program code of the selected second processor enclave includes requesting a cryptographic hash corresponding to the program code of the selected second processor enclave from the selected second processor enclave, receiving the cryptographic hash, and transmitting the received cryptographic hash to the remote requestor via the network for verification.

15. The method of claim 1, wherein the processing by the verified program code of the selected second processor enclave includes retrieving information associated with a user corresponding to the private information.

16. The method of claim 15, wherein the retrieved information includes identities of advertisements that have been presented to the user and timing information associated with when the advertisements were presented to the user.

17. The method of claim 1, wherein the processing by the verified program code of the selected second processor enclave includes generating labels indicating success or failure associated with advertisements presented to the user.

18. The method of claim 1, further comprising utilizing a result of the processing by the verified program code of the selected second processor enclave to train a machine learning model configured to select advertisements to present to a user.

19. A system, comprising:
one or more processors configured to:
receive from a remote requestor via a network a request for information to verify integrity of program code of a first processor enclave;
provide the requested information;
receive private information for use by the program code of the first processor enclave;
use the program code of the first processor enclave to select based at least in part on the received private information a second processor enclave among a plurality of different processor enclave options;
verify integrity of program code of the selected second processor enclave; and
provide at least a portion of the received private information to the selected second processor enclave for processing by the verified program code of the selected second processor enclave; and
a memory coupled to at least one of the one or more processors and configured to provide at least one of the one or more processors with instructions.

20. A computer program product embodied in a non-transitory computer readable medium and comprising computer instructions for:
receiving from a remote requestor via a network a request for information to verify integrity of program code of a first processor enclave;
providing the requested information;
receiving private information for use by the program code of the first processor enclave;
using the program code of the first processor enclave to select based at least in part on the received private information a second processor enclave among a plurality of different processor enclave options;
verifying integrity of program code of the selected second processor enclave; and
providing at least a portion of the received private information to the selected second processor enclave for processing by the verified program code of the selected second processor enclave.
